(19) United States
(12) Patent Application Publication
(10) Pub. No.: US 2015/0354527 A1
(43) Pub. Date: Dec. 10, 2015

(54) HYDRAULIC POWER GENERATION DEVICE

(71) Applicant: SHUI-CHUAN CHEN, TAINAN CITY (TW)

(72) Inventor: SHUI-CHUAN CHEN, TAINAN CITY (TW)

(21) Appl. No.: 14/300,320

(22) Filed: Jun. 10, 2014

(51) Int. Cl. F03B 13/08

(52) U.S. Cl. CPC F03B 13/08; Y10S 415/916; F03B 17/005

(57) ABSTRACT

A hydraulic power generation device includes a water passage unit which has a high end and a low end, and multiple water turbines are located above the water passage unit. Multiple containers are located beneath the water passage unit and located corresponding to the water turbines respectively. The water passage unit has an inlet and an outlet located corresponding to each of the containers. The inlet and the outlet communicate with the room of the container corresponding thereto. When one of the water turbines or the electric power generator needs to be maintained, the seal of the inlet is opened and the water flows to the water passage unit via the outlet to drive the water turbines behind the damaged water turbine. The hydraulic power generation device is still under operation while one of the water turbines is under maintenance.

### BACKGROUND OF THE INVENTION

1. Fields of the Invention

The present invention relates to a hydraulic power generation device, and more particularly, to a hydraulic power generation device which comprises multiple water passage units which are able to be maintained individually.

2. Descriptions of Related Art

The conventional hydraulic power generation device is built in those areas with plenty of water and generally comprises water passages with a high end and a low end, multiple water turbines are located above the water passages so as to be driven by the water to generate mechanical energy. An electric power generation unit is connected to and driven by each of the water turbines to transform the mechanical energy into electric energy. However, when one of the mills or the electric power generation unit needs to be maintained, in order to keep the water away from the water turbine or the electric power generation unit to avoid dangerous result, the operation of the whole hydraulic power generation device has to be stopped until the maintenance is finished. The conventional way of maintenance reduces the efficiency of the hydraulic power generation device. Frequent switching on and off will also shorten the life of use of the hydraulic power generation device.

The present invention intends to provide a hydraulic power generation device which eliminates the shortcomings mentioned above.

### SUMMARY OF THE INVENTION

The present invention relates to a hydraulic power generation device and comprises a water passage unit which has a high end and a low end, and multiple water turbines are located above the water passage unit. Multiple containers are located beneath the water passage unit and located corresponding to the water turbines respectively. The water passage unit has an inlet and an outlet located corresponding to each of the containers. The inlet and the outlet communicate with the room of the container corresponding thereto. Each of the inlet and the outlet is sealed by a seal. Each water turbine is connected with an electric power generator and an electric power storage unit is connected with the electric power generators.

When one of the water turbines or the electric power generator needs to be maintained, the seal of the inlet is opened and the water flows to the water passage unit via the outlet to drive the water turbines behind the damaged water turbine. The hydraulic power generation device is still under operation while one of the water turbines is under maintenance.

The primary object of the present invention is to provide a hydraulic power generation device which does not need to stop the operation of the hydraulic power generation device while one of the water turbines or the electric power generator needs to be repaired.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the hydraulic power generation device of the present invention;

FIG. 2 shows the water passage and the water turbines of the hydraulic power generation device of the present invention;

FIG. 3 shows the operation status of the water passage and the water turbines of the hydraulic power generation device of the present invention, and

FIG. 4 is a cross sectional view of another embodiment of the hydraulic power generation device of the present invention.

### DETAILED DESCRIPTION OF THE PREFERRED EMBODIMENT

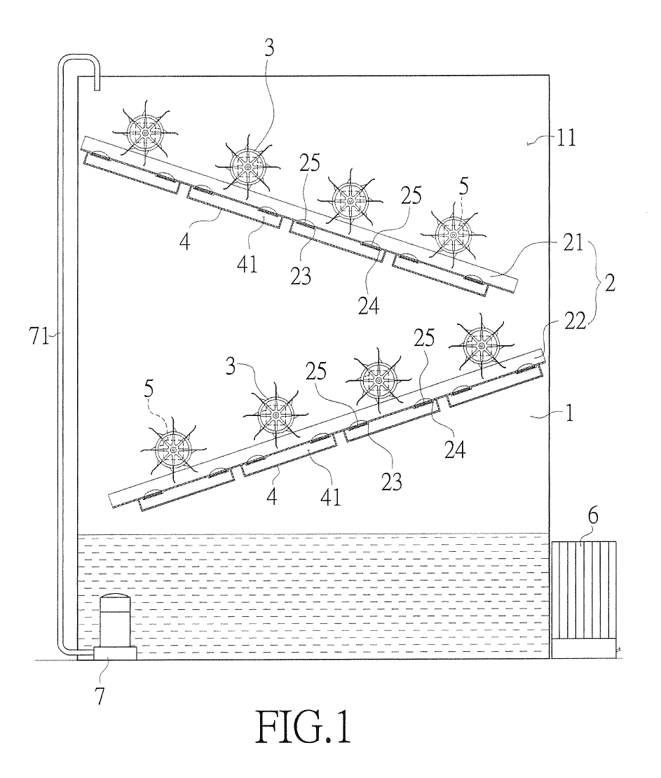

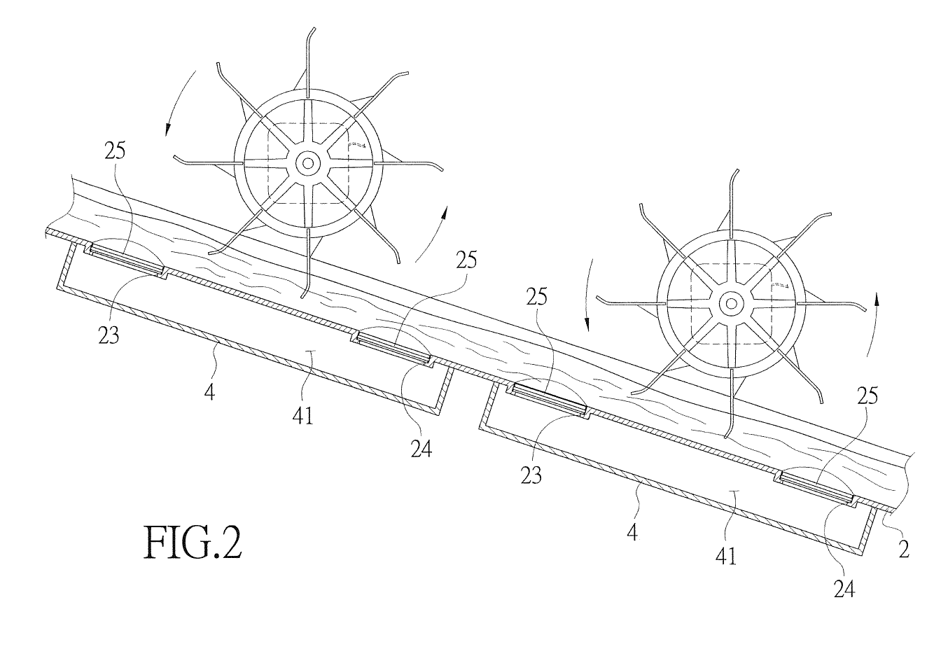

Referring to FIGS. 1 and 2, the hydraulic power generation device of the present invention comprises a case 1 which has a space 11 defined therein and a water passage unit 2 is located in the space 11. In this embodiment, there are at least two water passage units 2, and each water passage unit 2 has a high end and a low end. Taken one of the two water passage units 2 as an example to be described, the water passage unit 2 comprises a first passage 21 and a second water passage 22 which is located below the first passage 21. The first passage 21 is an inclined passage and has a low end and a high end, and the second passage 22 is an inclined passage and has a low end and a high end. The low end of the first passage 21 is located corresponding to the high end of the second passage 22. The first and second passages 21, 22 are inclined toward different directions.

Multiple water turbines 3 are located above the water passage unit 2, and a portion of each water turbine 3 is located within the water passage unit 2 so that the water rotates the blades of the water turbine 3. Multiple containers 4 are located beneath the water passage unit 2 and located corresponding to the water turbines 3 respectively. Each container 4 has a room 41 defined therein. The water passage unit 2 has an inlet 23 and an outlet 24 located corresponding to each of the containers 4. Each of the water turbines 3 is located between the inlet 23 and the outlet 24 of the container 4 corresponding to the water turbine 3. The inlet 23 and the outlet 24 communicate with the room 41 of the container 4 corresponding thereto. Each of the inlets 23 and the outlets 24 has a seal 25 connected thereto. Each water turbine 3 is connected with an electric power generator 5 which is connected with an electric power storage unit 6. The electric power generator 5 and the electric power storage unit 6 are located outside of the case 1. A pump 7 is located in the space 11 of the case 1. The pump 7 is connected to a first end of a pipe 71, a second end of the pipe 71 extends to a first opening 121 of the case 1 and is located high end of the water passage unit 2.

The space 11 is filled a certain height of water and the water level is higher than the pump 7. When the pump 7 is activated, the water in the space 11 is pumped to the upper portion of the space 11 via the pipe 71, and the water flows to the high end of the first passage 21. The water then flows downward along the first passage 21 and toward the low end of the first passage 21. The water flows to the high end of the second passage 22 via the low end of the first passage 21, and the water flows downward along the second passage 22 and toward the low end of the second passage 22. The water flows downward along the third passage, the fourth passage (if available) and so on. The water flows back to the initial water level in the case 1. The water is again pumped by the pump 7 to go through the cycle mentioned again.

When the water flows downward, the water turbines 3 are driven and rotated so as to activate the electric power generators 5 that are connected with the water turbines 3 so as to generate electric power which is transported to the electric power storage unit 6.

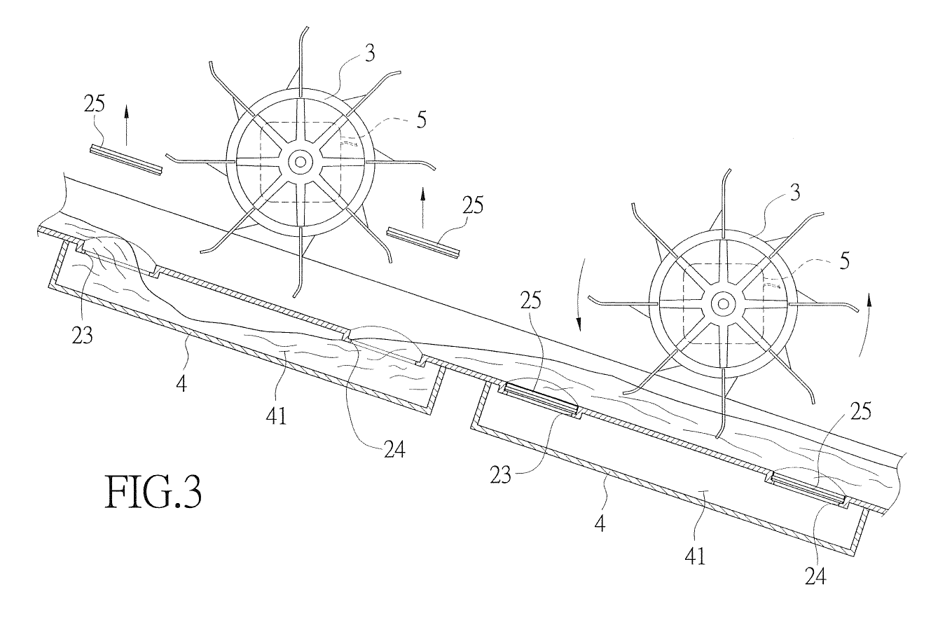

As shown in FIG. 3 when one of the water turbines 3 or the electric power generators 5 needs to be repaired or maintained, the seals 25 of the inlet 23 and the outlet 24 of the container 4 correspondent to the damaged water turbine 3 or the electric power generator 5 are opened. The water enters into the inlet 23 and the room 41 of the container 4, and flows out from the outlet 24 and back to the water passage unit 2 to continuously drive the rest of the water turbines 3. Therefore, the technician can access the damaged water turbine 3 or the electric power generator 5 while the hydraulic power generation device is still in operation. It is noted that the hydraulic power generation device does not need to be shut off while maintaining the damaged water turbine 3 or the electric power generator 5.

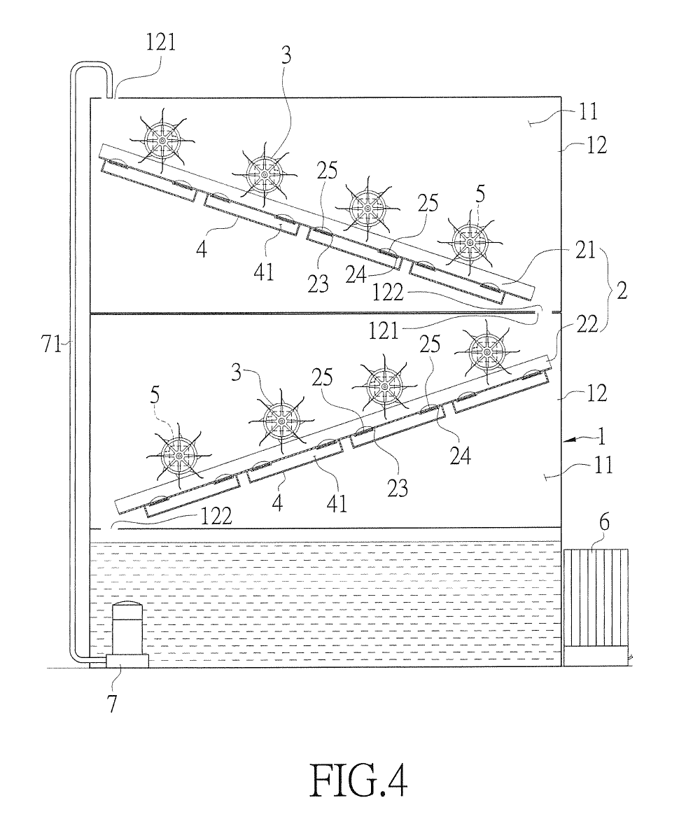

As shown in FIG. 4 which shows another embodiment of the present invention, wherein the case 1 comprises multiple boxes 12 which are overlapped with each other. Each box 12 has a space 11 defined therein. The space 11 of each of the boxes 12 has the water passage unit 2 and the multiple water turbines 3 received therein. The electric power generators 5 connected to the water turbines 3 are located outside of each of the boxes 12. The first and second passages 21, 22 are inclined toward different directions. Each box 12 has a first opening 121 and a second opening 122, the first opening 121 is located corresponding to the high end of the water passage unit 2, and the second opening 122 is located corresponding to the low end of the water passage unit 2. A pump 7 is located in the space 11 of the case 1 that is located at the lowest position of the overlapped boxes 12 in the case 1. The lowest box 12 has an open area in the top thereof. When in use, the water enters into the top box 12 via the first opening 121 of the top box 12, and the water flows downward along the water passage 2 unit 2 and out from the second opening 122. The water then flows into the second box 12 via the first opening 121 of the second box 12. The water flows through the multiple overlapped boxes 12 and drives the water turbines 3 to generate electric power. It is noted that number of the box 12 can be increased or decreased according to practical needs.

While we have shown and described the embodiment in accordance with the present invention, it should be clear to those skilled in the art that further embodiments may be made without departing from the scope of the present invention.

What is claimed is:

1. A hydraulic power generation device comprising:
a water passage unit which having a high end and a low end, multiple water turbines located above the water passage unit, a portion of each water turbine being located within the water passage unit, multiple containers located beneath the water passage unit and located corresponding to the water turbines respectively, each container having a room defined therein, the water passage unit having an inlet and an outlet located corresponding to each of the containers, each of the water turbines located between the inlet and the outlet of the container corresponding to the water turbine, the inlet and the outlet communicating with the room of the container corresponding thereto, each of the inlets and the outlets having a seal connected thereto, each water turbine connected with an electric power generator which is connected with an electric power storage unit.

2. The device as claimed in claim 1, wherein the water passage unit at least comprises a first passage and a second water passage which is located below the first passage, the first passage is an inclined passage and has a low end and a high end, the second passage is an inclined passage and has a low end and a high end, the low end of the first passage is located corresponding to the high end of the second passage, the first and second passages are inclined toward different directions.

3. The device as claimed in claim 2, wherein a case has a space defined therein and the water passage unit is located in the space, the electric power generator and the electric power storage unit are located outside of the case.

4. The device as claimed in claim 3, wherein the case comprises multiple boxes which are overlapped with each other, each box has a space defined therein, the space of each of the boxes has the water passage unit and the multiple water turbines received therein, the electric power generators connected to the water turbines are located outside of each of the boxes, each box has a first opening and a second opening, the first opening is located corresponding to the high end of the water passage unit, the second opening is located corresponding to the low end of the water passage unit.

5. The device as claimed in claim 4, wherein the first water passage and the second passage are respectively located in each two adjacent boxes.

6. The device as claimed in claim 5, wherein a pump is located in the space of the case that is located at the lowest position of the overlapped boxes in the case, the lowest box has an open area in a top thereof, the pump is connected to a first end of a pipe, a second end of the pipe extends to the first opening of the box located at the top of the overlapped boxes.

7. The device as claimed in claim 1, wherein a case has a space defined therein and the water passage unit is located in the space, the electric power generator and the electric power storage unit are located outside of the case.

8. The device as claimed in claim 7, wherein the case comprises multiple boxes which are overlapped with each other, each box has a space defined therein, the space of each of the boxes has the water passage unit and the multiple water turbines received therein, the electric power generators connected to the water turbines are located outside of each of the boxes, each box has a first opening and a second opening, the first opening is located corresponding to the high end of the water passage unit, the second opening is located corresponding to the low end of the water passage unit.

9. The device as claimed in claim 8, wherein a pump is located in the space of the case that is located at the lowest position of the overlapped boxes in the case, the lowest box has an open area in a top thereof, the pump is connected to a first end of a pipe, a second end of the pipe extends to the first opening of the box located at the top of the overlapped boxes.

10. The device as claimed in claim 7, wherein a pump is located in the space of the case, the pump is connected to a first end of a pipe, the case has a first opening defined in a top thereof, a second end of the pipe extends to the first opening of the case and located high end of the water passage unit.
